(19) United States
(12) Patent Application Publication
(10) Pub. No.: US 2014/0010618 A1
(43) Pub. Date: Jan. 9, 2014

(54) SCREW

(71) Applicants: CHENG-HONG SHEU, KAOHSIUNG CITY (TW); KUAN-HONG SHEU, KAOHSIUNG CITY (TW)

(72) Inventors: CHENG-HONG SHEU, KAOHSIUNG CITY (TW); KUAN-HONG SHEU, KAOHSIUNG CITY (TW)

(21) Appl. No.: 13/543,922

(22) Filed: Jul. 9, 2012

(51) Int. Cl. F16B 25/10

(52) U.S. Cl. 411/387.2

(57) ABSTRACT

A screw comprises a head, a shank disposed at one end of the head and provided with two inclined surfaces at a distal end thereof, at a joint of the inclined surfaces is formed an inclined reaming edge, at least one thread wound around a lateral surface of the shank and a positioning tip disposed at a middle section of the reaming edge. The positioning tip of the screw is firstly abutted against an object to be locked, so as to fix the screw to the object to be locked and prevent the screw from swinging. And then, the reaming edge of the shank performs the reaming operation in the object to be locked, and finally the thread performs cutting and locking operations, which can reduce the extruded material around the locking hole and prevent the object from being ruptured or deformed.

### BACKGROUND OF THE INVENTION

1. Field of the Invention

The present invention relates to a screw, and more particularly to a screw capable of improving the drilling stability.

2. Description of the Prior Art

A conventional screw usually comprises a head having one end defined with a locking hole and the other end provided with a shank. The shank is formed with a tapered end portion at one side which opposite the head and is provided with a threaded portion spirally wound around a lateral surface thereof. During the drilling process, the user firstly inserts a hand tool into the locking hole, and then turns the hand tool to make the screw rotate and drill, and finally locks the screw in an object to be locked after one end of the screw is abutted against the object to be locked.

However, when the end of the screw is locked in the object to be locked gradually, the outer diameter of the end increases gradually, such that the diameter of a drilling hole drilled into the object to be locked will be increased gradually, the material around the drilling hole will be extruded laterally by the end of the screw, and the extruded material will enter the threaded portion, which results in rupture or deformation of the object to be locked. Moreover, the screw is likely to be deflected during the locking process, making the screw unstable.

The present invention has arisen to mitigate and/or obviate the afore-described disadvantages.

### SUMMARY OF THE INVENTION

The primary objective of the present invention is to provide a screw which can prevent an object to be locked from being ruptured and improve the locking stability.

To achieve the above objective, the screw comprises:

a head;

a shank disposed at one end of the head and provided with two inclined surfaces at a distal end thereof, at a joint of the inclined surfaces is formed an inclined reaming edge;

at least one thread wound around a lateral surface of the shank; and

a positioning tip disposed at a middle section of the reaming edge.

During the locking process, the positioning tip of the screw is firstly abutted against an object to be locked, which enables the positioning tip to insert into a pre-locking hole area of the object to be locked easily, so as to fix the screw to the object to be locked and prevent the screw from swinging, thus improving the locking stability. And then, the reaming edge of the shank performs the reaming operation in the pre-locking hole area of the object to be locked so as to form a locking hole, and finally the thread performs cutting and locking operations, which can reduce the extruded material around the locking hole during the cutting process of the thread and prevent the object from being ruptured or deformed.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of a screw in accordance with the present invention;

FIG. 2 is a side view of the screw in accordance with the present invention;

FIG. 3 is a front view of the screw in accordance with the present invention; and

FIG. 4 is a bottom view of the screw in accordance with the present invention.

### DETAILED DESCRIPTION OF THE PREFERRED EMBODIMENTS

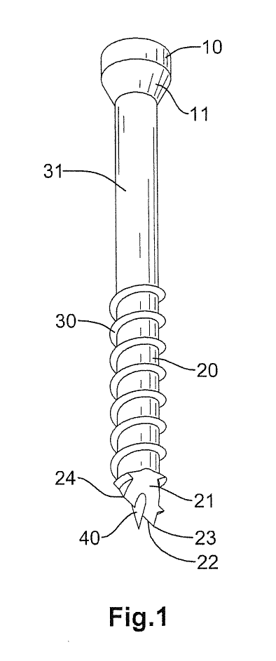

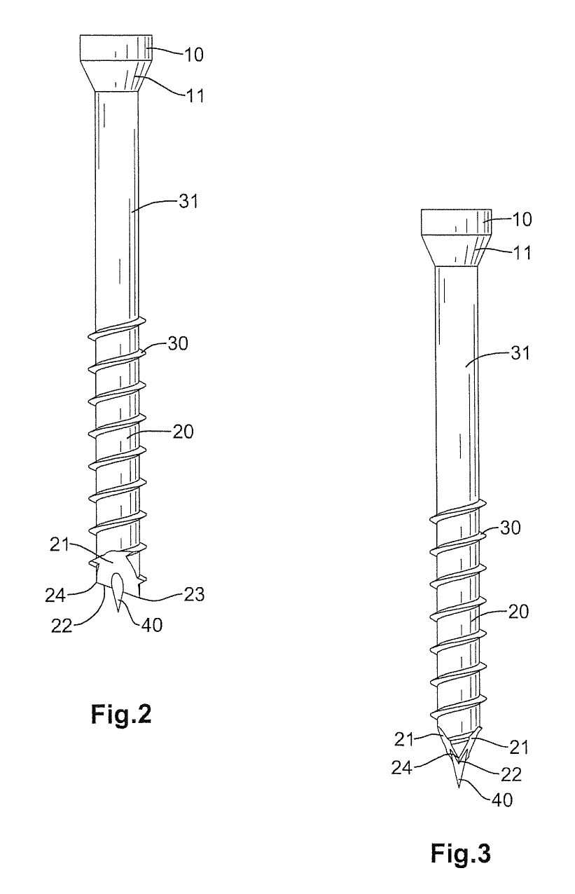

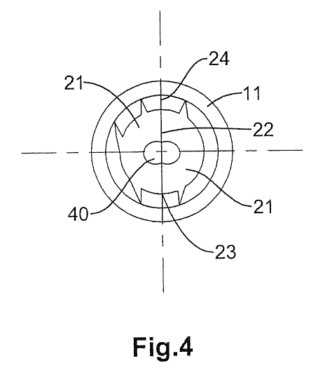

Referring to FIGS. 1-4, a screw in accordance with the present invention comprises a head 10, a shank 20, at least one thread 30 and a positioning tip 40.

One end of the head 10 is defined with a locking groove, and the other end of the head 10 is provided with a conical surface 11 having radially disposed protruding ribs (not shown). The shank 20 is laterally extended from the conical surface 11 of the head 10 and is provided with two inclined surfaces 21 at a distal end thereof, and at the joint of the inclined surfaces 21 is formed an inclined reaming edge 22. At the joint of the reaming edge 22 and a lateral surface of the shank 20 is formed a first endpoint 23 and a second endpoint 24, the first and second endpoints 23 and 24 are located at different horizontal surfaces, and an inclined angle of the reaming edge 22 relative to the horizontal surface can be adjusted according to different requirements. In addition, an angle between the inclined surfaces 21 can be an acute angle, an obtuse angle, between 0 to 180 degrees, or can be adjusted according to different requirements.

The thread 30 is spirally wound around the lateral surface of the shank 20, such a thread can be designed to be one or two, that is, a clockwise thread and a counter-clockwise thread, and the spiral directions of the clockwise and counter-clockwise threads are opposite. In addition, at least one unthreaded section 31 is defined in the shank 20 and is located between the clockwise thread and the counter-clockwise thread.

The positioning tip 40 is disposed at a middle section of the reaming edge 22 and is conical, the first endpoint 23 is located nearer a distal end of the positioning tip 40 than the second endpoint 24, and the distal end of the positioning tip 40 and the first endpoint 23 can be located at the same or different horizontal surfaces.

During the locking process, the positioning tip 40 of the screw is firstly abutted against an object to be locked, which enables the positioning tip 40 to insert into a pre-locking hole area of the object to be locked easily since the area of the distal end of the positioning tip 40 which contacts the object is small, so as to fix the screw to the object to be locked, and then the reaming edge 22 of the shank 20 performs the reaming operation in the pre-locking hole area of the object to be locked so as to form a locking hole, and finally the thread 30 performs cutting and locking operations, so as to make the screw lock in the object to be locked stably.

To summarize, the positioning tip 40 of the screw can improve the positioning stability during the locking process, so as to prevent the screw from swinging, thus improving the locking stability. In addition, the reaming edge 22 firstly performs the reaming operation in the object to be locked so as to form a locking hole, and then the thread 30 performs cutting and locking operations, which can reduce the extruded material around the locking hole during the cutting process of the thread 30 and prevent the object from being ruptured or deformed.

While we have shown and described various embodiments in accordance with the present invention, it should be clear to those skilled in the art that further embodiments may be made without departing from the scope of the present invention.

What is claimed is:

1. A screw comprising:
a head;
a shank disposed at one end of the head and provided with two inclined surfaces at a distal end thereof, at a joint of the inclined surfaces being formed an inclined reaming edge;
at least one thread spirally wound around a lateral surface of the shank; and
a positioning tip disposed at a middle section of the reaming edge.

2. The screw as claimed in claim 1, wherein at a joint of the reaming edge and the lateral surface of the shank is formed a first endpoint and a second endpoint, the first endpoint is located nearer a distal end of the positioning tip than the second endpoint.

3. The screw as claimed in claim 2, wherein the positioning tip is conical.

4. The screw as claimed in claim 3, wherein an angle between the inclined surfaces is an acute angle.

5. The screw as claimed in claim 1, wherein the positioning tip is conical.
